(19) United States
(12) Patent Application Publication
(10) Pub. No.: US 2016/0298969 A1
(43) Pub. Date: Oct. 13, 2016

(54) GRACEFUL SENSOR DOMAIN RELIANCE TRANSITION FOR INDOOR NAVIGATION

(71) Applicant: Exactigo, Inc., Vienna, VA (US)

(72) Inventors: Lloyd Franklin Glenn, III, Vienna, VA (US); Ann Christine Irvine, Eagle Point, OR (US)

(21) Appl. No.: 14/921,660

(22) Filed: Oct. 23, 2015

Related U.S. Application Data
(60) Provisional application No. 62/144,792, filed on Apr. 8, 2015.

(51) Int. Cl. G01C 21/20; G01C 21/16

(52) U.S. Cl. CPC G01C 21/206; G01C 21/165

(57) ABSTRACT

Some embodiments include a method of switching between different methods (e.g., domains) of computing location of an end-user device. For example, the end-user device can retrieving a building model from a backend server system. The building model can characterize a building in the physical world. The end-user device can collect sensor data corresponding to the multiple interrelated domains utilizing sensor components. The end-user device can determine a position of the end-user device by computing a first location based on sensor data in a first domain and a first domain map that correlates to and align with a physical domain map. The end-user device can then compute a second location based on sensor data of a second domain of the multiple inter-related domains and a second domain map that correlates to and align with the physical domain map. The end-user device can then determine its position on the physical domain map based on a weighted function of the first location at a first weight and the second location at a second weight.

### CROSS-REFERENCE To RELATED APPLICATIONS

This application claims the benefit of U.S. Provisional Patent Application No. 62/144,792, entitled “GRACEFUL SENSOR DOMAIN RELIANCE TRANSITION FOR INDOOR NAVIGATION,” filed Apr. 8, 2015, which is incorporated by reference herein in its entirety.

### TECHNICAL FIELD

Several embodiments relate to a location-based service system, and in particular, a location-based service.

### BACKGROUND

Mobile devices typically provide wireless geolocation services to the public as navigational tools. These services generally rely exclusively on a combination of global positioning service (GPS) geolocation technology and cell tower triangulation to provide a real-time position information for the user. Many users rely on these navigation services daily for driving, biking, hiking, and to avoid obstacles, such as traffic jams or accidents. Although popular and widely utilized, the technological basis of these services limits their applications to outdoor activities.

While the outdoor navigation space may be served by the GPS and cellular triangulation technologies, indoor geolocation/navigation space is far more challenging. These navigational services enable people to rely on their wireless devices to safely arrive at a general destination. Once they are in indoor settings, users are forced to holster their wireless device and revert to using antiquated (and often out-of-date) physical directories, information kiosks, printed maps, or website directions to arrive at their final destination.

The technical limitations of existing geolocation solutions have forced service providers to explore alternative technologies to solve the indoor navigation puzzle. Some systems rely on user-installed short-range Bluetooth beacons to populate the indoor landscape thus providing a network of known fixed emitters for wireless devices to reference. Other systems rely on costly user-installed intelligent Wi-Fi access points to assist wireless devices with indoor navigation requirements. Both of these “closed system” approaches seek to overcome the inherent difficulties of accurately receiving, analyzing, and computing useful navigation data in classic indoor RF environments by creating an artificial “bubble” where both emitters and receivers are controlled. These “closed” systems require large investments of resources when implemented at scale. While end-users are conditioned to expect wireless geolocation technologies to be ubiquitous and consistent, these closed systems typically are unable to satisfy this need.

### DISCLOSURE OVERVIEW

In several embodiments, an indoor navigation system includes a location service application running on an end-user device, a site survey application running on a surveyor device, and a backend server system configured to provide location-based information to facilitate both the location service application and the site survey application. The site survey application and the backend server system are able to characterize existing radiofrequency (RF) signatures in an indoor environment.

Part of the challenge with in-building navigation on wireless devices is the material diversity of the buildings themselves. Wood, concrete, metals, plastics, insulating foams, ceramics, paint, and rebar can all be found in abundance within buildings. These materials each create their own localized dielectric effect on RF energy. Attenuation, reflection, amplification, and/or absorption serve to distort the original RF signal. The additive and often cooperative effects of these building materials on RF signals can make creating any type of useful or predictive algorithm for indoor navigation difficult. Every building is different in its composition of material.

Despite this, the indoor navigation system is able to account for and use to its advantage these challenges. The indoor navigation system can be used in all building types despite differences in material composition. The indoor navigation system can account for the specific and unique characteristics of different indoor environment (e.g., different building types and configurations). The indoor navigation system can utilize the survey application to characterize existing/native RF sources and reflection/refraction surfaces using available RF antennas and protocols in mobile devices (e.g., smart phones, tablets, etc.).

For example, the surveyor device and the end-user device can each be a mobile device configured respectively by a special-purpose application running on its general-purpose operating system. The mobile device can have an operating system capable of running one or more third-party applications. For example, the mobile device can be a tablet, a wearable device, or a mobile phone.

In several embodiments, the indoor navigation system fuses RF data with input data generated by onboard sensors in the surveyor device or end-user device. For example, the onboard sensors can be inertial sensors, such as accelerometer, compass (e.g., digital or analog), a gyroscope, a magnetometer, or any combination thereof. The inertial sensors can be used to perform “dead reckoning” in areas of poor RF signal coverage. The indoor navigation system can leverage accurate and active 2D or 3D models of the indoor environment to interact with users. The indoor navigation system can actively adapt to changes in the building over its lifetime.

In several embodiments, the indoor navigation system fuses virtual sensor data with RF data and data generated by onboard sensors. A virtual sensor can be implemented by a physics simulation engine (e.g., a game engine). For example, the physics simulation engine can include a collision detection engine. Utilizing a probabilistic model (e.g., particle filter or other sequential Monte Carlo methods) of probable location and probable path, the physics simulation engine, and hence the virtual sensor, can compute weights to adjust computed locations using other sensors (e.g., inertial sensors, Wi-Fi sensors, cellular sensors, RF sensors, etc.). The indoor navigation system can leverage virtual sensors based on the active 2D or 3D models of the indoor environment. For example, the virtual sensor can detect objects and pathways in the 2D or 3D model. The virtual sensor can detect one or more paths between objects in the 2D or 3D model. The virtual sensor can compute the distance between one or more paths between objects (e.g., virtual objects and representation of physical objects, including humans) in the 2D or 3D model. The paths identified by the virtual sensor can be assigned a weighting factor by the indoor navigation system. The virtual sensor can detect collisions between objects in the 2D or 3D model. The virtual sensor fused with inertial sensors can provide an “enhanced dead reckoning” mode in areas of poor RF signal coverage. The virtual sensor receiving RF sensors and inertial sensors measurements can provide a further enhanced indoor navigation system.

These advantages are achieved via indoor geolocation processes and systems that can accurately recognize, interpret, and react appropriately based on the RF, physical characteristics, and 2D or 3D models of a building. The indoor navigation system can dynamically switch and/or fuse data from different sensor suites available on the standard general-purpose mobile devices. The indoor navigation system can further complement this data with real time high resolution RF survey and mapping data available in the backend server system. This end-user device can then present a Virtual Simulation World constructed based on the data fusion. For example, the Virtual Simulation World is rendered as an active 2D or 3D indoor geolocation and navigation experience. The Virtual Simulation World includes both virtual objects and representations of physical objects or people.

For example, the indoor navigation system can create a dynamic three-dimensional (3D) virtual model of a physical building, using physics simulation engines (e.g., game engines) that are readily available on several mobile devices. A physics simulation engine can be designed to simulate realistic sense of the laws of physics to simulate objects. The physics simulation engine can be implemented via a graphics processing unit (GPU), a hardware chip set, a software framework, or any combination thereof. The physics simulation engine can also include a rendering engine capable of visually modeling virtual objects or representations of physical objects. This virtual model includes the RF and physical characteristics of the building as it was first modeled by a surveyor device or by a third party entity. The indoor navigation system can automatically integrate changes in the building or RF environment over time based on real-time reports from one or more instances of site survey applications and/or location service applications. Day to day users of the indoor navigation system interact with the 2D or 3D model either directly or indirectly and thus these interactions can be used to generate further data to update the 2D or 3D virtual model. The mobile devices (e.g., the surveyor devices or the end-user devices) can send model characterization updates to the backend server system (e.g., a centralized cloud service) on an “as needed” basis to maintain the integrity and accuracy of the specific building's 2D or 3D model. This device/model interaction keeps the characterizations of buildings visited up to date thus benefitting all system users.

The indoor navigation system can seamlessly feed building map data and high-resolution 2D or 3D RF survey data to instances of the location service application running on the end-user devices. The location service application on an end-user device can then use the 2D or 3D RF survey data and building map data to construct an environment for its navigation and positioning engines to present to the users. The indoor navigation system can include a 2D or 3D Virtual Model (e.g., centralized or distributed) containing physical dimensions (geo-position, scale, etc.), unique RF characterization data (attenuation, reflection, amplification, etc.), and virtual model characterization data (obstacle orientation, pathway weighting, etc.). The fusion of these data sets enables the location service application on the end-user device to accurately determine and represent its own location within a Virtual World presented to the user. The indoor navigation system further enables one end-user device to synchronize its position and building models with other end-user devices to provide an even more accurate location-based or navigation services to the users. These techniques also enable an end-user device to accurately correlate its position in the 2D or 3D Virtual World with a real-world physical location (e.g., absolute or relative to known objects) of the end-user device. Thus, the user gets a live 2D or 3D Virtual indoor map/navigation experience based on accurate indoor geolocation data. In some embodiments, there is a 2D or 3D virtual world running on the 3D engine in the device, but the user interface can be a 2D map—or can just be data that is fed to another mapping application for use by that application.

In the event the end-user device detects that it is about to enter a radio-challenged area (e.g., dead-zone) of a building, the end-user device can seamlessly switch into an enhanced dead-reckoning mode, relying on walking pace and bearing data collected and processed by the end-user device's onboard sensor suite (e.g., inertial sensors, virtual sensor, etc.). In the Virtual World displayed to the end-user, this transition will be seamless and not require any additional actions/input.

The indoor geolocation/navigation solution described above enables a single application to function across many buildings and scenarios. With a rapidly growing inventory of building data, users ultimately would be able to rely on a single, multi-platform solution to meet their indoor navigation needs. A solution that works regardless of building type, network availability, or wireless device type; a solution that works reliably at scale, and a solution that does not require the installation/maintenance of costly proprietary “closed system” emitters in every indoor space.

With multiple domains available for location correlation, the end-user device can adaptively add more and less weight to each of the domains when computing the position of the end-user. These weights can reflect the reliability of the domain. If a domain is of low reliability within a known region, it is not relied upon as heavily as those domains that have been determined to be of high confidence.

For example, when an end-user has entered a room, and a building model indicates that the room has low reliability in a Wi-Fi domain, the adaptive geolocation algorithm of the indoor navigation system can lower the weight corresponding to the Wi-Fi domain or increase weights of other remaining domains. For example, a walking pattern observed through an accelerometer domain and correlated against a pathway detected by a virtual sensor domain can be relied upon more heavily.

For another example, the end-user can be tracked from room to room with high correlation between an existing virtual building and a physical building. The end-user can enter a room with very low signal strength or ID in one RF domain, e.g., Wi-Fi or cellular. The location service application of the end-user device can immediately begin tracking and storing all kinetic information (e.g., inertial and virtual sensor information) leading up to and within the room such that the user's movement within the room can be determined. The location service application can flag the room as having low signal or having high signal variance, and this heightened characterization can be reported back to the backend server system for storage into the building model corresponding to the virtual room. When subsequent users enter the room, the location service applications of those user devices can access the building model and know, a priori, that there is a low-signal or unreliable signal room ahead. Accordingly, the end-user devices of those subsequent users can select the appropriate sensors that are more reliable for location estimation. In some embodiments, those end-user devices can still collect all sensor data in case new sources have become available. In some embodiments, while all sensor data are still collected, the sampling rate of unreliable sensors are decreased to conserve power. If a room had a temporary outage in one or more RF domains, the building model can self-correct and over time heal the hostile label from the room based on reports from one or more end-user devices.

Some embodiments of this disclosure have other aspects, elements, features, and steps in addition to or in place of what is described above. These potential additions and replacements are described throughout the rest of the specification

### BRIEF DESCRIPTION OF THE DRAWINGS

FIG. 1 is a block diagram illustrating an indoor navigation system, in accordance with various embodiments.

FIG. 2 is a block diagram illustrating a mobile device, in accordance with various embodiments.

FIG. 3 is an activity flow diagram of a location service application running on an end-user device, in accordance with various embodiments.

FIG. 4 is an activity flow diagram of a site survey application running on a surveyor device, in accordance with various embodiments.

FIG. 5A is a perspective view illustration of a virtual world rendered by the location service application, in accordance with various embodiments.

FIG. 5B is a top view illustration of a virtual simulation world rendered as a two-dimensional sheet by the location service application, in accordance with various embodiments.

FIG. 6 is a flow chart of a method of producing an immersive virtual world correlated to the physical world in real-time, in accordance with various embodiment.

FIG. 7 is a block diagram of an example of a computing device, which may represent one or more computing device or server described herein, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

### Glossary

“Physical” refers to real or of this world. Hence, the “Physical World” refers to the tangible and real world. A “Physical Map” is a representation (e.g., a numeric representation) of at least a part of the Physical World. “Virtual” refers to an object or environment that is not part of the real world and implemented via one or more computing devices. For example, several embodiments can include a “virtual object” or a “virtual world.” A virtual world environment can include virtual objects that interact with each other. In this disclosure, a “virtual simulation world” refers to a particular virtual environment that is configured to emulate some properties of the Physical World for purposes of providing one or more navigational or location-based services. The “virtual simulation world” can fuse properties from both the physical world and a completely virtual world. For example, the user can be represented as a virtual object (e.g., avatar) in a 2D or 3D model of a building which has been constructed to emulate physical properties (e.g., walls, walkways, etc. extracted from a physical map). The movement of the virtual object can be based upon the indoor navigation system—an algorithm based on physical characteristics of the environment. The virtual simulation world can be a virtual environment with virtual elements augmented by physical (“real or of this world”) elements. In some embodiments, the virtual simulation world comprises models (e.g., 2D or 3D models) of buildings, obstructions, point of interest (POI) markers, avatars, or any combination thereof. The virtual simulation world can also include representations of physical elements, such as 2D maps, WiFi profiles (signature “heat maps”), etc.

In some cases, a virtual object can be representative of a physical object, such as a virtual building representing a physical building. In some cases, a virtual object does not have a physical counterpart. A virtual object may be created by software. Visualizations of virtual objects and worlds can be created in order for real humans to see the virtual objects as 2D and/or 3D images (e.g., on a digital display). Virtual objects exist while their virtual world exists—e.g., while an application or process is being executed on a processing device that establishes the virtual world.

A “physical building” is a building that exists in the real/physical world. For example, humans can touch and/or walk through a physical building. A “virtual building” refers to rendition of one or more 2D or 3D electronic/digital model(s) of physical buildings in a virtual simulation world.

A “physical user” is a real person navigating through the real world. The physical user, can be a user of a mobile application as described in embodiments of this disclosure. The physical user can be a person walking through one or more physical buildings while using the mobile application.

A “virtual user” refers to a rendition of a 2D or 3D model, representing the physical user, in a virtual simulation world. The virtual simulation world can include a virtual building corresponding to a physical building. The virtual user can interact with the virtual building in the virtual simulation world. A visualization of this interaction can be simultaneously provided to the physical user through the mobile application.

A “domain” refers to a type of sensed data analysis utilizing one type of sensor devices (e.g., standardized transceiver/antenna, motion sensor, etc.). For example, the “Wi-Fi Domain” pertains to data analysis of Wi-Fi radio frequencies; the “Cellular Domain” pertains to data analysis of cellular radio frequencies (e.g., cellular triangulation); the “GPS Domain” pertains to data analysis of latitude and longitude readings by one or more GPS modules. For example, the GPS Domain can include a GPS(Device) subdomain that pertains to data analysis of latitude and longitude readings as determined by a mobile device or a GPS(AccessPt) subdomain that pertains to data analysis of latitude and longitude readings as determined by a Wi-Fi access point. These domains can be referred to as “RF domains.”

For another example, a “Magnetic Domain” pertains to data analysis of magnetometer readings; a “Gyroscope Domain” pertains to data analysis of gyroscope readings from a gyroscope; and the “Accelerometer Domain” pertains to data analysis of kinetic movement readings from an accelerometer. A “Virtual Sensor Domain” pertains to data analysis utilizing a physics simulator engine. These domains can be referred to as “kinetic domains.” In other examples, an “Image Recognition Domain” pertains to data analysis of real-time images from a camera, an “Audio Recognition Domain” pertains to data analysis of real-time audio clips from a microphone, and a “Near Field Domain” pertains to data analysis of near field readings from a near field communication (NFC) device (e.g., radiofrequency ID (RFID) device).

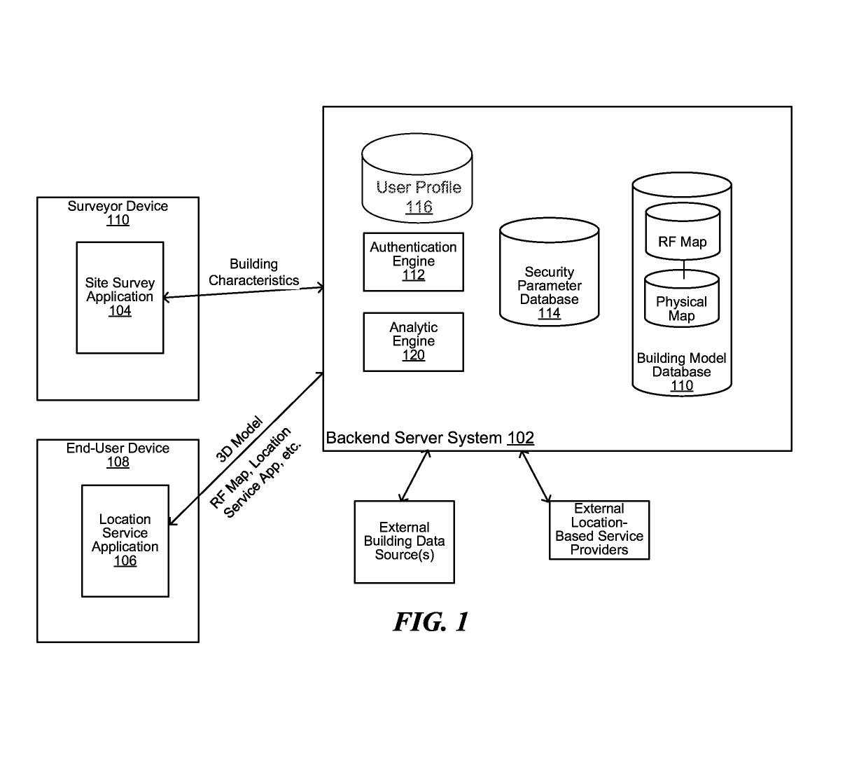

FIG. 1 is a block diagram illustrating an indoor navigation system 100, in accordance with various embodiments. The indoor navigation system 100 provides in-building location-based services for licensed commercial host applications or its own agent client applications on end-user devices. For example, the indoor navigation system 100 includes a backend server system 102, a site survey application 104, and a location service application 106. Commercial customers, who would like to add the functionalities of the indoor navigation system 100, can couple to the indoor navigation system 100 through the use of an application programming interface (API) and/or embedding of a software development kit (SDK) in their native applications or services (e.g., web services). In several embodiments, the indoor navigation system 100 can support multiple versions and/or types of location service applications. For illustrative purposes, only the location service application 106 is shown in FIG. 1.

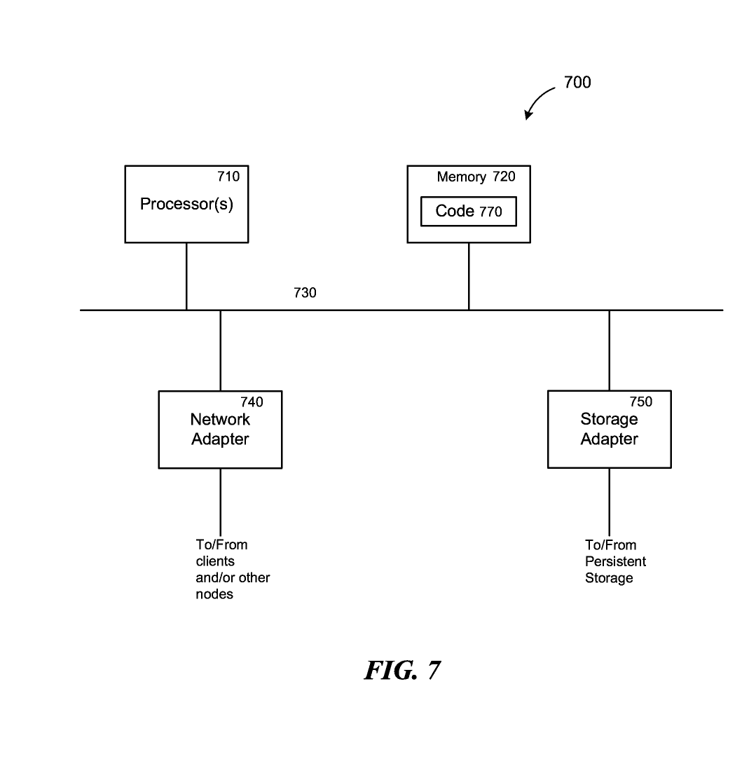

The backend server system 102 includes one or more computing devices, such as one or more instances of the computing device 700 of FIG. 7. The backend server system 102 provides data to deploy the location service application 106. The backend server system 102 can interact directly with the location service application 106 when setting up an active online session.

The backend server system 102 can provide data access to a building model database 110. For example, the building model database 110 can include a building model for an indoor environment (e.g., a building project, a public or semipublic building, etc.). The building model can include physical structure information (e.g., physical domains) and radio frequency (RF) information (e.g., RF domains), as well as other sensor data such as magnetic fields.

The backend server system 102 can provide a user authentication service via an authentication engine 112. The authentication engine 112 enables the backend server system 102 to verify that a user requesting building information from the building model database 110 is authorized for such access. The authentication engine 112 can access a security parameter database 114, indicating security settings (e.g., usage licenses and verification signatures) protecting one or more of the building models in the building model database 110. For example, the security settings can indicate which users are authorized for access. The backend server system 102 can provide a user profile database 116. The user profile database 116 can include user activity log (e.g., for error tracking and usage accounting purposes).

The location service application 106 is a client application (e.g., agent application) of the backend server system 102 that geo-locates an end-user device 108 (to which the location service application 106 is running on) based on an adaptive geolocation algorithm. In several embodiments, the end-user device 108 is a mobile device, such as a wearable device, a tablet, a cellular phone, a tag, or any combination thereof. The end-user device 108 can be an electronic device having a general-purpose operating system thereon that is capable of having other third-party applications running on the operating system. The adaptive geolocation algorithm can be based at least on a RF map (e.g., two-dimensional or three-dimensional RF map in the building model) associated with an indoor environment, the physical map (e.g., two-dimensional or three-dimensional physical map in the building model) of the indoor environment, sensor readings in the end-user device 108, or any combination thereof. The location service application 106 can receive sensor readings from one or more antennas (e.g., cellular antenna, Wi-Fi antenna, Bluetooth antenna, near field communication (NFC) antenna, or any combination thereof) and/or inertial sensors (e.g., an accelerometer, a gyroscope, a magnetometer, a compass, or any combination thereof). The adaptive geolocation algorithm combines all sensory data available to the end-user device 108 and maps the sensory data to the physical building map and the RF map.

In some embodiments, the location service application 106 can feed the sensory data to the backend server system 102 for processing via the adaptive geolocation algorithm. In some embodiments, the location service application 106 can compute the adaptive geolocation algorithm off-line (e.g., without the involvement of the backend server system 102). In some embodiments, the location service application 106 and the backend server system 102 can share responsibility for executing the adaptive geolocation algorithm (e.g., each performing a subset of the calculations involved in the adaptive geolocation algorithm). Regardless, the location service application 106 can estimate (e.g., calculated thereby or received from the backend server system 102) a current location of the end-user device 108 via the adaptive geolocation algorithm.

The backend server system 102 can include an analytic engine 120. The analytic engine 120 can perform least statistical analysis, predictive modeling, machine learning techniques, or any combination thereof. The analytic engine 120 can generate insights utilizing those techniques based on either stored (e.g., batch data), and/or real-time data collected from End User Device and/or Surveyor Device. Results from the analytics engine 120 may be used to update surveyor workflow (e.g., where to collect WiFi signal information based on location confusion metrics), update End User Device signal RF maps, update pathways in 2D or 3D models (e.g., based on pedestrian traffic), update weights on a sensor channel/domain, or any combination thereof.

In some embodiments, the estimated current location of the end-user device 108 can take the form of earth-relative coordinates (e.g., latitude, longitude, and/or altitude). In some embodiments, the estimated location can take the form of building relative coordinates that is generated based on a grid system relative to borders and/or structures in the building model.

The location service application 106 can report the estimated current location to a commercial host application either through mailbox updates or via asynchronous transactions as previously configured in the host application or the location service application 106. In some embodiments, the location service application 106 executes in parallel to the host application. In some embodiments, the location service application 106 is part of the host application.

In several embodiments, the location service application 106 can require its user or the host application's user to provide one or more authentication parameters, such as a user ID, a project ID, a building ID, or any combination thereof. The authentication parameters can be used for user identification and usage tracking.

In several embodiments, the location service application 106 is configured to dynamically adjust the frequency of sensor data collection (e.g., more or less often) to optimize device power usage. In some embodiments, the adaptive geolocation algorithm can dynamically adjust weights on the importance of different RF signals and/or motion sensor readings depending on the last known location of the end-user device 108 relative to the building model. The adjustments of these ways can also be provided to the end-user device via the backend server system 102. For example in those embodiments, the location service application 106 can adjust the frequency of sensor data collection from a sensor channel based on a current weight of the sensor channel computed by the adaptive geolocation algorithm.

In several embodiments, the location service application 106 can operate in an off-line mode. In those embodiments, the location service application 106 stores a building model or a portion thereof locally on the end-user device 108. For example, the location service application 106 can, periodically, according to a predetermined schedule, or in responsive to a use request, download the building model from the backend server system 102. In these embodiments, the location service application 106 can calculate the estimated current location without involvement of the backend server system 102 and/or without an Internet connection. In several embodiments, the downloaded building model and the estimated current location is encrypted in a trusted secure storage managed by the location service application 106 such that an unauthorized entity cannot access the estimated current location nor the building model.

The site survey application 104 is a data collection tool for characterizing an indoor environment (e.g., creating a new building model or updating an existing building model). For example, the site survey application 104 can sense and characterize RF signal strength corresponding to a physical map to create an RF map correlated with the physical map. The users of the site survey application 104 can be referred to as “surveyors.”

In several embodiments, the site survey application 104 is hosted on a surveyor device 110, such as a tablet, a laptop, a mobile phone, or any combination thereof. The surveyor device 110 can be an electronic device having a general-purpose operating system thereon that is capable of having other third-party applications running on the operating system. A user of the site survey application 104 can walk through/traverse the indoor environment, for example, floor by floor, as available, with the surveyor device 110 in hand. The site survey application 104 can render a drawing of the indoor environment as a whole and/or a portion of the indoor environment (e.g., a floor) that is being surveyed.

In some embodiments, the site survey application 104 indicates the physical location of the user at regular intervals on an interactive display overlaid on the rendering of the indoor environment. The site survey application 104 can continually sample from one or more sensors (e.g., one or more RF antennas, a global positioning system (GPS) module, an inertial sensor, or any combination thereof) in or coupled to the surveyor device 110 and store both the physical location and the sensor samples on the surveyor device 110. An “inertial sensor” can broadly referred to electronic sensors that facilitate navigation via dead reckoning. For example, an inertial sensor can be an accelerometer, a rotation sensor (e.g., gyroscope), an orientation sensor, a position sensor, a direction sensor (e.g., a compass), a velocity sensor, or any combination thereof.

In several embodiments, the surveyor device 110 does not require active connectivity to the backend server system 102. That is, the site survey application 104 can work offline and upload log files after sensor reading collection and characterization of an indoor environment have been completed. In some embodiments, the site survey application 104 can execute separately from the location service application 106 (e.g., running as separate applications on the same device or running on separate distinct devices). In some embodiments, the site survey application 104 can be integrated with the location service application 106.

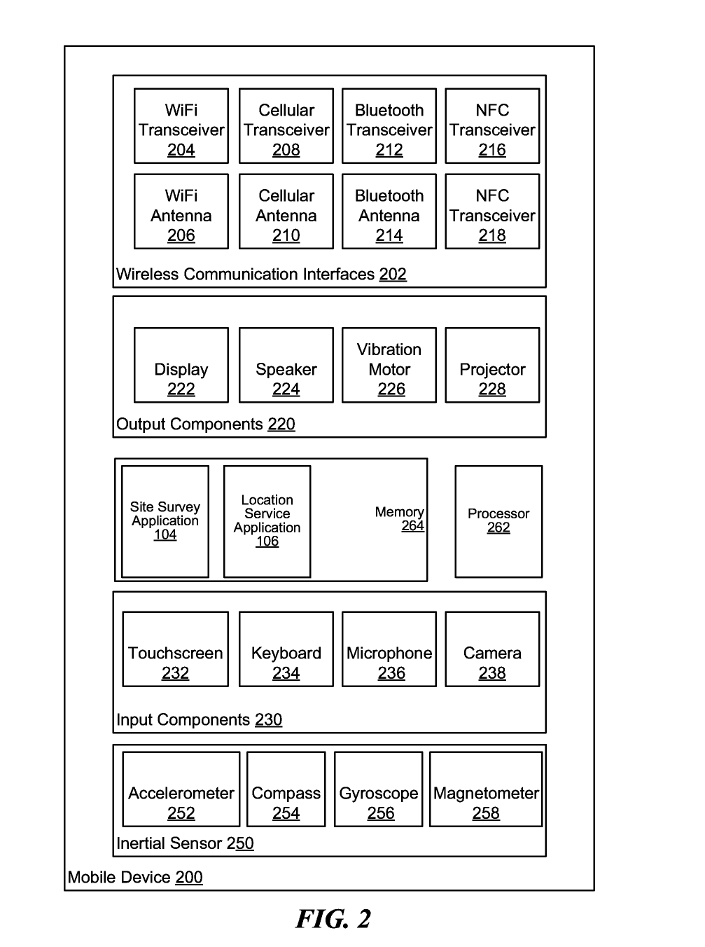

FIG. 2 is a block diagram illustrating a mobile device 200 (e.g., the end-user device 108 or the surveyor device 110 of FIG. 1), in accordance with various embodiments. The mobile device 200 can store and execute the location service application 106 and/or the site survey application 104. The mobile device 200 can include one or more wireless communication interfaces 202. For example, the wireless communication interfaces 202 can include a Wi-Fi transceiver 204, a Wi-Fi antenna 206, a cellular transceiver 208, a cellular antenna 210, a Bluetooth transceiver 212, a Bluetooth antenna 214, a near-field communication (NFC) transceiver 216, a NFC antenna 218, other generic RF transceiver for any protocol (e.g., software defined radio), or any combination thereof.

In several embodiments, the site survey application 104 or the location service application 106 can use at least one of the wireless communication interfaces 202 to communicate with an external computer network (e.g., a wide area network, such as the Internet, or a local area network) where the backend server system 102 resides. In some embodiments, the site survey application 104 can utilize one or more of the wireless communication interfaces 202 to characterize the RF characteristic of an indoor environment that the site survey application 104 is trying to characterize. In some embodiments, the location service application can take RF signal readings from one or more of the wireless communication interfaces 202 to compare to expected RF characteristics according to a building model that correlates a RF map to a physical map.

The mobile device 200 can include one or more output components 220, such as a display 222 (e.g., a touchscreen or a non-touch-sensitive screen), a speaker 224, a vibration motor 226, a projector 228, or any combination thereof. The mobile device 200 can include other types of output components. In some embodiments, the location service application 106 can utilize one or more of the output components 220 to render and present a virtual simulation world that simulates a portion of the Physical World to an end-user. Likewise, in some embodiments, the site survey application 104 can utilize one or more of the output components 220 to render and present a virtual simulation world while a surveyor is using the site survey application 104 to characterize an indoor environment (e.g., in the Physical World) corresponding to that portion of the virtual simulation world.

The mobile device 200 can include one or more input components 230, such as a touchscreen 232 (e.g., the display 222 or a separate touchscreen), a keyboard 234, a microphone 236, a camera 238, or any combination thereof. The mobile device 200 can include other types of input components. In some embodiments, the site survey application 104 can utilize one or more of the input components 230 to capture physical attributes of the indoor environment that the surveyor is trying to characterize. At least some of the physical attributes, such as photographs or videos of the indoor environment or surveyor comments/description as text, audio or video, can be reported to the backend server system 102 and integrated into the building model. In some embodiments, the location service application 106 can utilize the input components 230 such that the user can interact with virtual objects within the virtual simulation world. In some embodiments, detection of interactions with a virtual object can trigger the backend server system 102 or the end-user device 108 to interact with a physical object (e.g., an external device) corresponding to the virtual object.

The mobile device 200 can include one or more inertial sensors 250, such as an accelerometer 252, a compass 254, a gyroscope 256, a magnetometer 258, other motion or kinetic sensors, or any combination thereof. The mobile device 200 can include other types of inertial sensors. In some embodiments, the site survey application 104 can utilize one or more of the inertial sensors 250 to correlate dead reckoning coordinates with the RF environment it is trying to survey. In some embodiments, the location service application 106 can utilize the inertial sensors 250 to compute a position via dead reckoning. In some embodiments, the location service application 106 can utilize the inertial sensors 250 to identify a movement in the Physical World. In response, the location service application 106 can render a corresponding interaction in the virtual simulation world and/or report the movement to the backend server system 102.

The mobile device 200 includes a processor 262 and a memory 264. The memory 265 stores executable instructions that can be executed by the processor 262. For example, the processor 262 can execute and run an operating system capable of supporting third-party applications to utilize the components of the mobile device 200. For example, the site survey application 104 or the location service application 106 can run on top of the operating system.

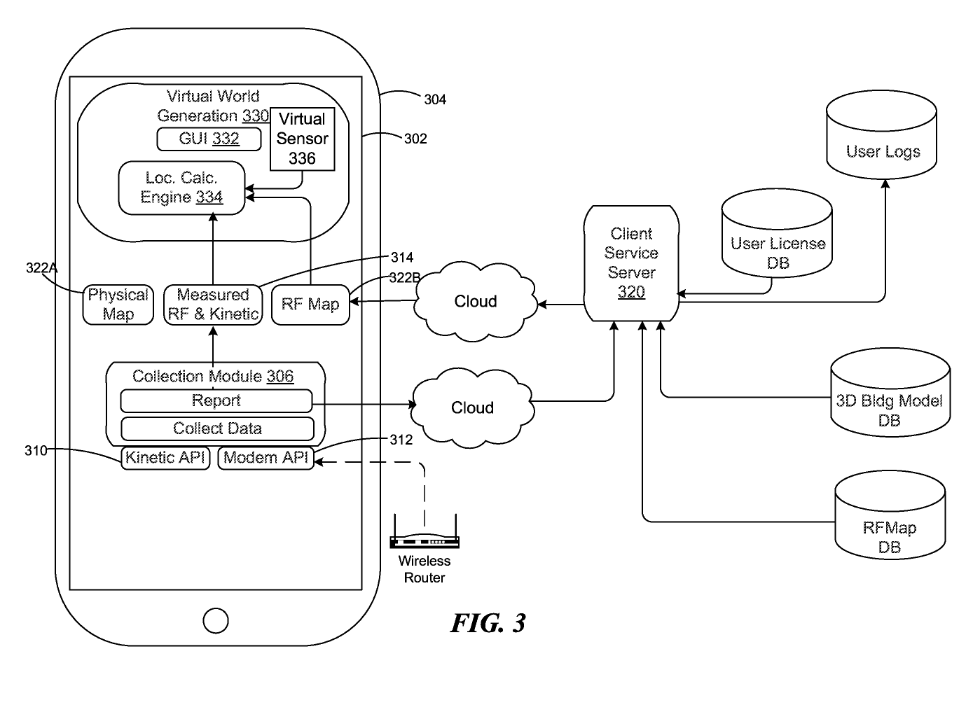

FIG. 3 is an activity flow diagram of a location service application 302 (e.g., the location service application 106 of FIG. 1) running on an end-user device 304 (e.g., the end-user device 108 of FIG. 1), in accordance with various embodiments. A collection module 306 of the location service application 302 can monitor and collect information pertinent to location of the end-user device 304 from one or more inertial sensors and/or one or more wireless communication interfaces. For example, the collection module 306 can access the inertial sensors through a kinetic application programming interface (API) 310. For another example, the collection module 306 can access the wireless communication interfaces through a modem API 312. In turn, the collection module 306 can store the collected data in a collection database 314 (e.g., measured RF attributes and inertial sensor readings). The collection module 306 can also report the collected data to a client service server 320 (e.g., a server in the backend server system 102 of FIG. 1)

The location service application 302 can also maintain a building model including a physical map portion 322A, a RF map portion 322B, and/or other sensory domain maps (collectively as the “building model 322). In some embodiments, the physical map portion 322A and the RF map portion 322B are three dimensional. In other embodiments, the physical map portion 322A and the RF map portion 322B are represented by discrete layers of two-dimensional maps.

The location service application 302 can include a virtual simulation world generation module 330. The virtual simulation world generation module 330 can include a graphical user interface (GUI) 332, a location calculation engine 334, and a virtual sensor 336 (e.g., implemented by a physics simulation engine). The location calculation engine 334 can compute and in-model location of the end-user device 304 based on the building model 322 and the collected data in the collection database 314.

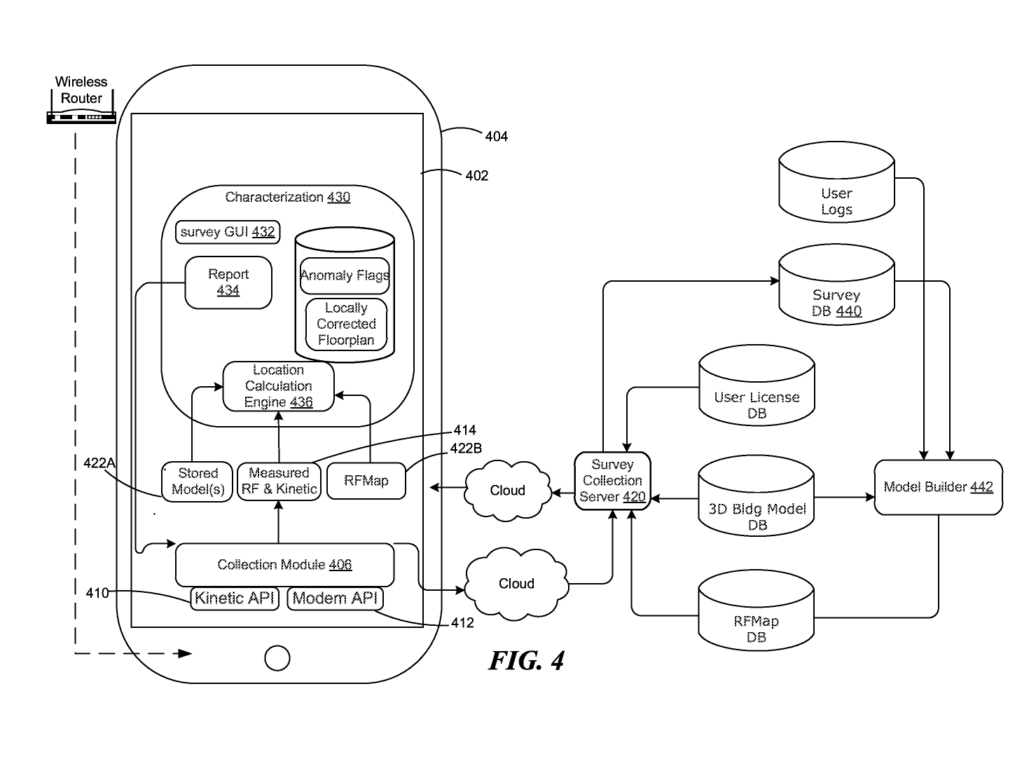

FIG. 4 is an activity flow diagram of a site survey application 402 (e.g., the site survey application 104 of FIG. 1) running on a surveyor device 404 (e.g., the surveyor device 110 of FIG. 1), in accordance with various embodiments. The site survey application 402 can include a collection module 406 similar to the collection module 306 of FIG. 3.

In turn, the collection module 406 can store the collected data in a collection database 414 (e.g., measured RF attributes and inertial sensor readings). The collection module 406 can also report the collected data to a survey collection server 420 (e.g., a server in the backend server system 102 of FIG. 1). The location service application 302 can also maintain a building model including a physical map portion 422A and a RF map portion 422B, and/or other sensory domain maps (collectively as the “building model 422), similar to the building model 322 of FIG. 3.

The site survey application 402 can include a characterization module 430. The characterization module 430 can include a survey GUI 432, a report module 434 (e.g., for reporting survey data and floorplan corrections to the survey collection server 420), and a location calculation engine 436. The location calculation engine 436 can function the same as the location calculation engine 334 of FIG. 3. The location calculation engine 436 can compute an in-model location of the surveyor device 404 based on the building model 422 and the collected data in the collection database 414. Based on the computed in-model location, the characterization module 430 can identify anomaly flags within the building model 422 that needs adjustment and produce a locally corrected building model (e.g., in terms of RF domains or kinetic domain).

After the survey collection server 420 receives survey data (e.g., the collected data, anomaly flags and the locally corrected building model) from the surveyor device 404, the survey collection server 420 can store the survey data in a survey database 440. A model builder server 442 (e.g., the same or different physical server as the survey collection server 420) can build or update the building model based on the survey data. For example, the model builder server 442 can update the RF map or the physical map. In some embodiments, the model builder server 442 can further use user data from the end-user devices reported overtime to update the building model.

Functional components (e.g., engines, modules, and databases) associated with devices of the indoor navigation system 100 can be implemented as circuitry, firmware, software, or other functional instructions. For example, the functional components can be implemented in the form of special-purpose circuitry, in the form of one or more appropriately programmed processors, a single board chip, a field programmable gate array, a network-capable computing device, a virtual machine, a cloud computing environment, or any combination thereof. For example, the functional components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Each of the functional components may operate individually and independently of other functional components. Some or all of the functional components may be executed on the same host device or on separate devices. The separate devices can be coupled through one or more communication channels (e.g., wireless or wired channel) to coordinate their operations. Some or all of the functional components may be combined as one component. A single functional component may be divided into sub-components, each sub-component performing separate method step or method steps of the single component.

In some embodiments, at least some of the functional components share access to a memory space. For example, one functional component may access data accessed by or transformed by another functional component. The functional components may be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implements a portion of the functional components). The systems, engines, or devices described may include additional, fewer, or different functional components for various applications.

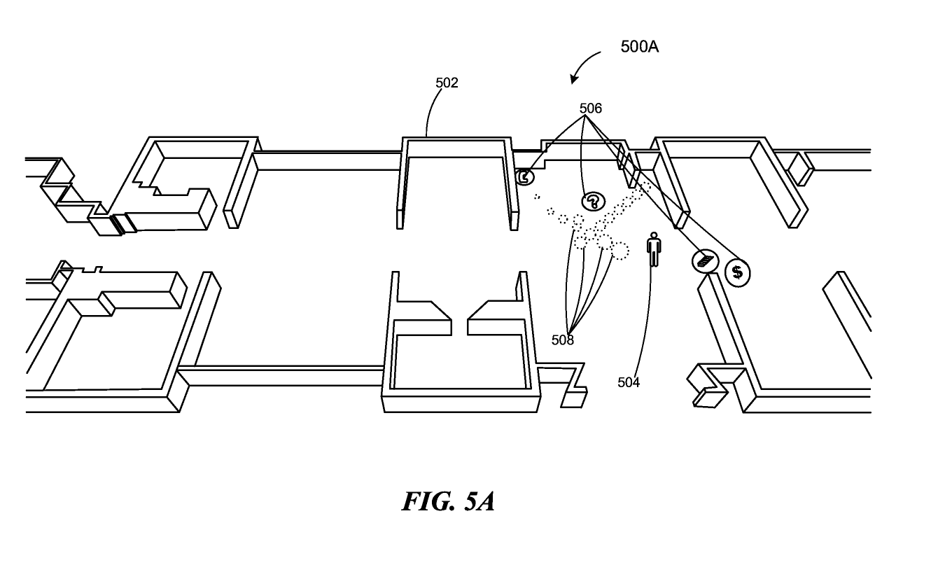

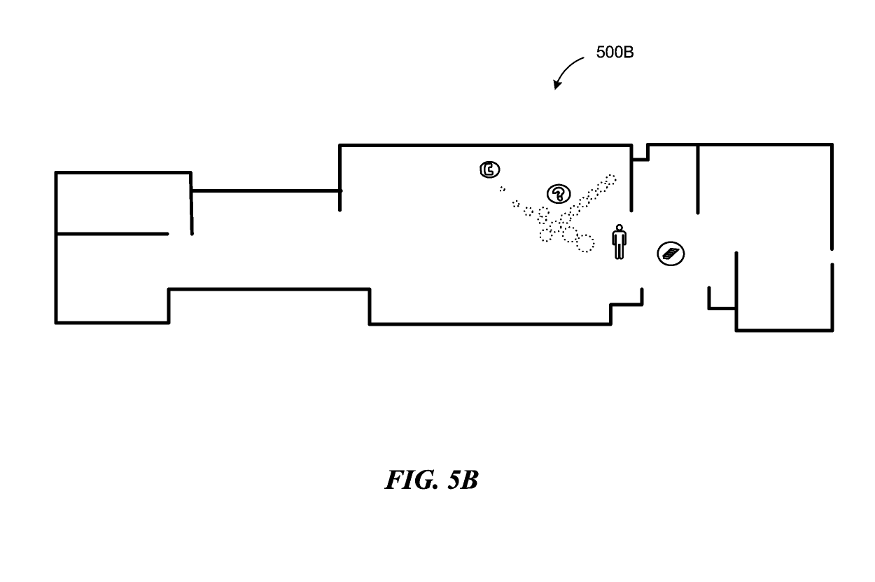

FIG. 5A is a perspective view illustration of a virtual simulation world 500A rendered by the location service application (e.g., the location service application 106 of FIG. 1), in accordance with various embodiments. For example, the virtual simulation world 500A can be rendered on an output component of the end-user device 108. The virtual simulation world 500A can include a virtual building 502 based on a physical map portion of a building model produced by the indoor navigation system 100. The virtual simulation world 500A can further include a user avatar 504 representing an end-user based on a calculated location determined by the location service application. For example, that calculation may be based on both the physical map portion and the RF map portion of the building model.

Some embodiments include a two-dimensional virtual simulation world instead. For example, FIG. 5B is a top view illustration of a virtual simulation world 500B rendered as a two-dimensional sheet by the location service application (e.g., the location service application 106 of FIG. 1), in accordance with various embodiments.

The virtual simulation world 500A can include building features 506, such as a public telephone, an information desk, an escalator, a restroom, or an automated teller machine (ATM). In some embodiments, the virtual simulation world 500A can include rendering of virtual RF sources 508. These virtual RF sources 508 can represent RF sources in the Physical World. The size of the virtual RF sources 508 can represent the signal coverage of the RF sources in the Physical World.

In this example illustration, the virtual simulation world 500A is rendered in a third person perspective. However, this disclosure contemplates other camera perspectives for the virtual simulation world 500A. For example, the virtual simulation world 500A can be rendered in a first person's perspective based on the computed location and orientation of the end-user. The virtual simulation world 500A can be rendered from a user selectable camera angle.

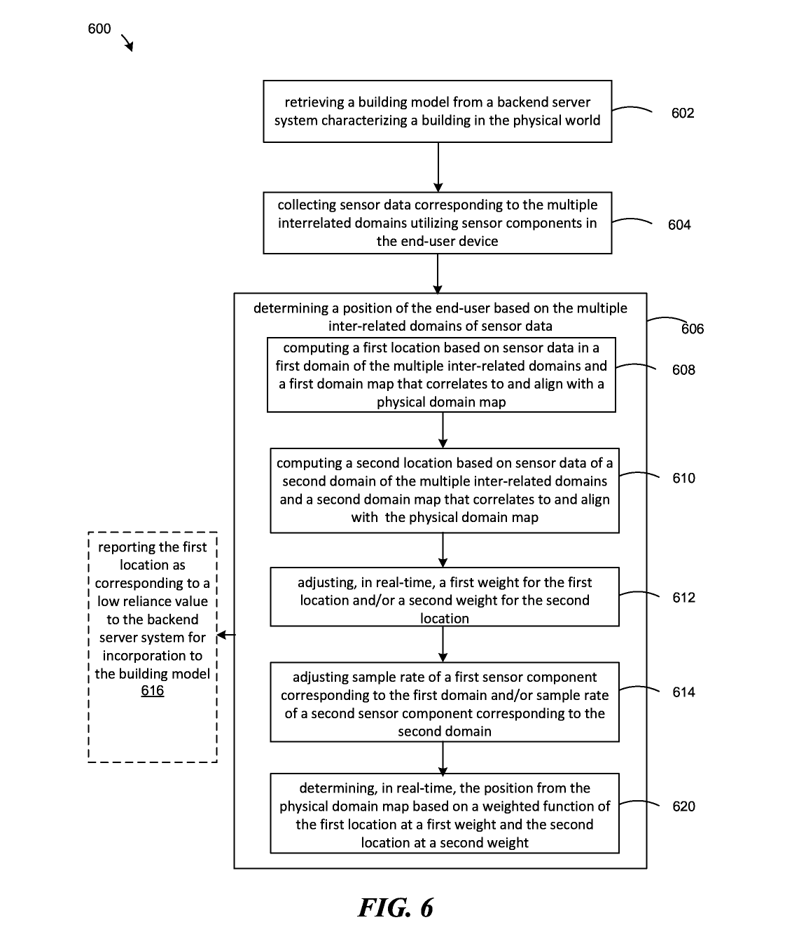

FIG. 6 is a flow chart of a method 600 of gracefully transitioning from reliance of one sensor domain to another during user localization, in accordance with various embodiments. The method 600 can be executed by a location service application running on an end-user device.

At step 602, the end-user device retrieves a building model from a backend server system characterizing a building in the physical world. The building model can have multiple inter-related domains of characterization including a radiofrequency (RF) domain map and a physical domain map. At step 604, the end-user device collects sensor data corresponding to the multiple interrelated domains utilizing sensor components in the end-user device. Collecting the sensor data can include determining, in real-time, data variance or signal power observed in the sensor data of each of the multiple inter-related domains.

At step 606, the end-user device determines a position of the end-user based on sensor data (e.g., the multiple inter-related domains of sensor data including inertial sensor data, wireless sensor data, virtual sensor data, or any combination thereof). For example, the end-user device can perform step 606 by executing the following sub-steps. At sub-step 608, the end-user device can compute a first location based on sensor data in a first domain of the multiple inter-related domains and a first domain map that correlates to and align with a physical domain map. At sub-step 610, the end-user device can compute a second location based on sensor data of a second domain of the multiple inter-related domains and a second domain map that correlates to and align with the physical domain map. For example, the first domain can be an inertial sensor domain and the second domain can be a RF domain. Computing the first location can include computing a dead reckoning location. Computing the second location can include computing a radiofrequency triangulation location based on the sensor data of the second domain. The RF domain can be a Wi-Fi communication domain, a Bluetooth communication domain, a cellular communication domain, or any combination thereof.

At sub-step 620, the end-user device can determine, in real-time, the position from the physical domain map based on a weighted function of the first location at a first weight and the second location at a second weight. In several embodiments, the building model indicates default values of the first weight and the second weight based on relative known accuracies of the first domain and the second domain. For example, the default weight of inertial sensor domains (e.g., using dead reckoning) can be lower than that of RF domains (e.g., using triangulation). The default values may be updated by the back-end server. For example, the end-user device may store an older locally stored map. The back-end server can update the weights of objects' locations based on analytics performed on users that have frequented that venue. As a result, the end-user device can update its RF map information.

In some embodiments, the first domain map indicates spatial reliability scores of the first domain. The spatial reliability scores can be indicative of likelihoods of error of the sensor data at different locations in the first domain. Prior to determining the position at sub-step 620, the end-user device can adjust, in real-time, the first weight at sub-step 612. For example, the end-user device can adjust the first weight relative to a first reliability score at the first location according to the spatial reliability scores. For another example, the end-user device can adjust the first weight relative to a first data variance or a first signal power of the first domain. In some embodiments, the virtual sensor data can update the weights (e.g., including the first weight) utilizing a particle filtering methodology . For example, a straight line path of a current particle to a next particle may be blocked by an obstruction and thus its weight reduced.

In some embodiments, the end-user device can further adjust sample rate of a first sensor component corresponding to the first domain at sub-step 614. For example, the end-user device can adjust the sample rate of the first sensor component based on the first reliability score at the first location. For another example, the end-user device can adjust the sample rate of the first sensor component based on the first data variance or the first signal power. In some embodiments, at step 616, responsive to determining that the first data variance or the first signal power has a value below a threshold, the end-user device can report the first location as corresponding to a low reliance value to the backend server system for incorporation to the building model.

The disclosed method enables the end-user device to determine when to rely on a particular domain of input signals and when to rely on a different domain of input signals. In one specific example, the end-user device may be used to explore a deep cave with magnets that are embedded in the walls (e.g., lots of iron). In this example, there is no WiFi, Bluetooth, cellular, or GPS available. In that case, the end-user device can rely on a Magnetometer Domain or other kinetic domains. In another example, the end-user device may be used to explore a remote area under an open sky, where the remote area has lots of virtual and physical obstacles defined in the 3D virtual world—e.g., a war zone. The virtual obstacles can be where potential hostile militants or devices may be. In this example, the end-user device can use the GPS domain and the virtual sensor domain without relying on the WiFi domain or the Cellular Domain. In yet another example, the end-user device may be used to explore an office building. In this example, the end-user device can use the WiFi domain and the virtual sensor domain.

While processes or blocks are presented in a given order in FIG. 6, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

FIG. 7 is a block diagram of an example of a computing device 700, which may represent one or more computing device or server described herein, in accordance with various embodiments. The computing device 700 can be one or more computing devices that implement the indoor navigation system 100 of FIG. 1. The computing device 700 includes one or more processors 710 and memory 720 coupled to an interconnect 730. The interconnect 730 shown in FIG. 7 is an abstraction that represents any one or more separate physical buses, point-to-point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 710 is/are the central processing units (CPUs) of the computing device 700 and thus controls the overall operation of the computing device 700. In certain embodiments, the processor(s) 710 accomplishes this by executing software or firmware stored in memory 720. The processor(s) 710 may be, or may include, one or more programmable general-purpose or special-purpose microprocessors, digital signal processors (DSPs), programmable controllers, application specific integrated circuits (ASICs), integrated or stand-alone graphics processing units (GPUs), programmable logic devices (PLDs), trusted platform modules (TPMs), or the like, or a combination of such devices.

The memory 720 is or includes the main memory of the computing device 700. The memory 720 represents any form of random access memory (RAM), read-only memory (ROM), flash memory, or the like, or a combination of such devices. In use, the memory 720 may contain a code 770 containing instructions according to the mesh connection system disclosed herein.

Also connected to the processor(s) 710 through the interconnect 730 are a network adapter 740 and a storage adapter 750. The network adapter 740 provides the computing device 700 with the ability to communicate with remote devices, over a network and may be, for example, an Ethernet adapter or Fibre Channel adapter. The network adapter 740 may also provide the computing device 700 with the ability to communicate with other computers. The storage adapter 750 enables the computing device 700 to access a persistent storage, and may be, for example, a Fibre Channel adapter or SCSI adapter.

The code 770 stored in memory 720 may be implemented as software and/or firmware to program the processor(s) 710 to carry out actions described above. In certain embodiments, such software or firmware may be initially provided to the computing device 700 by downloading it from a remote system through the computing device 700 (e.g., via network adapter 740).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), integrated or stand-alone graphics processing units (GPUs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification.

1. A computer-implemented method comprising:
retrieving a building model from a backend server system, wherein the building model characterizes a building in the physical world and has multiple inter-related domains of characterization, and wherein the building model includes a radiofrequency (RF) domain map and a physical domain map;
collecting sensor data corresponding to the multiple interrelated domains utilizing sensor components in the end-user device; and
determining a position of the end-user based on the multiple inter-related domains of sensor data by:
computing a first location based on sensor data in a first domain of the multiple inter-related domains and a first domain map that correlates to and align with the physical domain map;
computing a second location based on sensor data of a second domain of the multiple inter-related domains and a second domain map that correlates to and align with the physical domain map; and
determining the position from the physical domain map based on a weighted function of the first location at a first weight and the second location at a second weight.

2. The computer-implemented method of claim 1, further comprising receiving the first weight or the second weight from the backend server system.

3. The computer-implemented method of claim 1, wherein determining the position includes adjusting, in real-time, the first weight relative to a first reliability score at the first location and wherein the first spatial reliability score is indicative of likelihood of error of the sensor data in the first domain.

4. The computer-implemented method of claim 3, wherein the first domain map specifies spatial reliability scores of the first domain at different locations.

5. The computer-implemented method of claim 3, further comprising receiving the first domain map or the spatial reliability scores from the backend server system.

6. The computer-implemented method of claim 3, further comprising adjusting sample rate of a first sensor component corresponding to the first domain based on the first reliability score at the first location.

7. The computer-implemented method of claim 1, wherein the building model indicates default values of the first weight and the second weight based on relative known accuracies of the first domain and the second domain.

8. The computer-implemented method of claim 1, wherein collecting the sensor data includes determining, in real-time, a first data variance or a first signal power observed in the sensor data of the first domain; wherein determining the position includes adjusting, in real-time, the first weight relative to the first data variance or the first signal power.

9. The computer-implemented method of claim 8, further comprising adjusting, in real-time, sample rate of a first sensor component corresponding to the first domain based on the first data variance or the first signal power.

10. The computer-implemented method of claim 8, further comprising reporting the first location as corresponding to a low reliance value to the backend server system for incorporation to the building model responsive to determining that the first data variance or the first signal power has a low value relative to a threshold.

11. The computer-implemented method of claim 1, wherein the first domain is an inertial sensor domain, wherein computing the first location includes computing a dead reckoning location.

12. The computer-implemented method of claim 1, wherein the second domain is a RF domain, wherein computing the second location includes computing a radiofrequency triangulation location based on the sensor data of the second domain.

13. The computer-implemented method of claim 12, wherein the RF domain is a Wi-Fi communication domain, a Bluetooth communication domain, a cellular communication domain, or any combination thereof.

14. The computer-implemented method of claim 1, wherein the first domain is an inertial sensor domain augmented by a virtual sensor domain and wherein computing the first location is by adjusting a dead reckoning location based on the sensor data of the inertial sensor domain by computed weights of a physics simulation engine.

15. The computer-implemented method of claim 14, further comprising computing a likelihood of the dead reckoning location as the computed weight utilizing a collision avoidance engine and the building model.

16. A computer readable data memory storing computer-executable instructions that, when executed by a computer system, cause the computer system to perform a computer-implemented method, the instructions comprising:
retrieving a building model from a backend server system, wherein the building model characterizes a building in the physical world and has multiple inter-related domains of characterization, and wherein the building model includes a radiofrequency (RF) domain map and a physical domain map;
collecting sensor data corresponding to the multiple interrelated domains utilizing sensor components in the end-user device;
determining a position of the end-user based on the multiple inter-related domains of sensor data by:
computing a first location based on sensor data in a first domain of the multiple inter-related domains and a first domain map that correlates to and align with the physical domain map;
computing a second location based on sensor data of a second domain of the multiple inter-related domains and a second domain map that correlates to and align with the physical domain map; and
determining, in real-time, the position from the physical domain map based on a weighted function of the first location at a first weight and the second location at a second weight.

17. The computer readable data memory of claim 16, wherein determining the position includes adjusting, in real-time, the first weight relative to a first reliability score at the first location and wherein the first spatial reliability score is indicative of likelihood of error of the sensor data in the first domain.

18. The computer readable data memory of claim 16, wherein the first domain or the second domain includes an inertial sensor domain, a RF domain, a virtual sensor domain, or any combination thereof.

19. The computer readable data memory of claim 18, wherein the inertial sensor domain includes one or more sensor signals from a magnetometer, an accelerometer, a gyroscope, or any combination thereof.

20. The computer readable data memory of claim 16, wherein collecting the sensor data includes determining, in real-time, a first data variance or a first signal power observed in the sensor data of the first domain; wherein determining the position includes adjusting, in real-time, the first weight relative to the first data variance or the first signal power.

21. The computer readable data memory of claim 20, wherein the instructions further comprises: adjusting, in real-time, sample rate of a first sensor component corresponding to the first domain based on the first data variance or the first signal power.

22. A mobile device comprising:
a processor configured by executable instructions to:
retrieve a building model from a backend server system , wherein the building model characterizes a building in the physical world and has multiple inter-related domains of characterization, and wherein the building model includes a radiofrequency (RF) domain map and a physical domain map;
collect sensor data corresponding to the multiple interrelated domains utilizing sensor components in the end-user device;
determine a position of the end-user based on the multiple inter-related domains of sensor data by:
compute a first location based on sensor data in a first domain of the multiple inter-related domains and a first domain map that correlates to and align with the physical domain map;
compute a second location based on sensor data of a second domain of the multiple inter-related domains and a second domain map that correlates to and align with the physical domain map; and
determine the position from the physical domain map based on a weighted function of the first location at a first weight and the second location at a second weight.
